(19) United States
(12) Patent Application Publication
(10) Pub. No.: US 2025/0119845 A1
(43) Pub. Date: Apr. 10, 2025

(54) ELECTRONIC DEVICE COMPRISING ANTENNA AND METHOD FOR SAME

(71) Applicant: Samsung Electronics Co., Ltd., Suwon-si (KR)

(72) Inventors: Sungyoul CHO, Suwon-si (KR); Hyeyong GO, Suwon-si (KR); Jihun KIM, Suwon-si (KR); Jaeuk RYU, Suwon-si (KR); Kyoungsik YOON, Suwon-si (KR); Byungchul LEE, Suwon-si (KR); Yeongseob LIM, Suwon-si, (KR); Kyujae JANG, Suwon-si (KR); Muyoung CHOI, Suwon-si (KR)

(21) Appl. No.: 18/985,480

(22) Filed: Dec. 18, 2024

Related U.S. Application Data
(63) Continuation of application No. PCT/KR2023/008479, filed on Jun. 19, 2023.

(30) Foreign Application Priority Data
Jul. 6, 2022 (KR) 10-2022-0083322
Sep. 13, 2022 (KR) 10-2022-0115132

(51) Int. Cl. H04W 52/36; H04W 52/14; H04W 52/24

(52) U.S. Cl. CPC H04W 52/36; H04W 52/14; H04W 52/24

(57) ABSTRACT

Disclosed is an electronic device in a wireless communication system, the electronic device comprising: at least one processor, comprising processing circuitry, individually and/or collectively, configured to cause the electronic device to: receive a network signalling message from a base station; check whether a condition regarding uplink environment is satisfied; set a clipping amount to a first level and output a signal clipped to the first level based on the condition being satisfied; and set the clipping amount to a second level and output a signal clipped to the second level based on the condition not being satisfied.

### CROSS-REFERENCE TO RELATED APPLICATIONS

This application is a continuation of International Application No. PCT/KR2023/008479 designating the U.S., filed on Jun. 19, 2023, in the Korean Intellectual Property Receiving Office and claiming priority to Korean Patent Application Nos. 10-2022-0083322, filed on Jul. 6, 2022, and 10-2022-0115132, filed on Sep. 13, 2022, in the Korean Intellectual Property Office, the disclosures of each of which are incorporated by reference herein in their entireties.

### BACKGROUND

### Field

The disclosure relates to an electronic device including an antenna and a method thereof.

### Description of Related Art

As mobile communication technology evolves, multi-functional portable electronic devices are commonplace and, to meet demand for massive radio traffic, vigorous efforts are underway to develop fifth generation (5G) communication systems. To achieve a higher data transmission rate, 5G communication systems are being implemented on ultra-high frequency bands as well as those used for 3G communication systems and long-term evolution (LTE) communication systems.

The frequencies that electronic devices use in communication systems include frequency bands, such as 2.3 GHz and 3.5 GHZ, which are used for military radar, satellite digital radio, and satellite operations. This has led to 3GPP standards limiting the maximum level of spurious emissions to minimize interference with the frequencies that need to be protected.

The electronic device may determine the transmission power by applying maximum output power requirements. For example, the maximum output power requirements may be a maximum power reduction (MPR) value and/or an additional-MPR (A-MPR) value.

### SUMMARY

According to an example embodiment of the disclosure, an electronic device of a wireless communication system may comprise: at least one processor, comprising processing circuitry, individually and/or collectively, configured to cause the electronic device to: receive a network signaling message from a base station; identify whether a condition for an uplink environment is satisfied; based on the condition being satisfied, set a clipping amount to a first level and output a signal clipped to the first level; and based on the condition not being satisfied, set the clipping amount to a second level and output a signal clipped to the second level.

According to an example embodiment of the disclosure, in a method by an electronic device in a wireless communication system, the method comprising: receiving a network signaling message from a base station; identifying whether a condition for an uplink environment is satisfied; based on the condition being satisfied, perform the operation of setting a clipping amount to a first level and outputting a signal clipped to the first level; and based on the condition not being satisfied, setting the clipping amount to a second level and outputting a signal clipped to the second level.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a view illustrating an example electronic device in a network environment according to various embodiments;

FIG. 2A is a block diagram illustrating an example configuration of an electronic device in a network environment including a plurality of cellular networks according to various embodiments;

FIG. 2B is a diagram illustrating a change in uplink coverage due to a reduction in maximum transmission power of an electronic device according to various embodiments;

FIG. 3A is a diagram illustrating an example configuration of an electronic device according to various embodiments;

FIG. 3B is a diagram illustrating a digital domain of an example configuration of an electronic device according to various embodiments;

FIG. 4 is a diagram illustrating a change in output of an RFIC according to various embodiments;

FIG. 5A is a flowchart illustrating example operations of an electronic device according to various embodiments;

FIG. 5B is a flowchart illustrating example operations of an electronic device according to various embodiments;

FIG. 6A is a graph illustrating a spurious specification and a measurement value of a spurious component; and

FIG. 6B is a graph illustrating a reduction in spurious component according to a power setting according to various embodiments.

### DETAILED DESCRIPTION

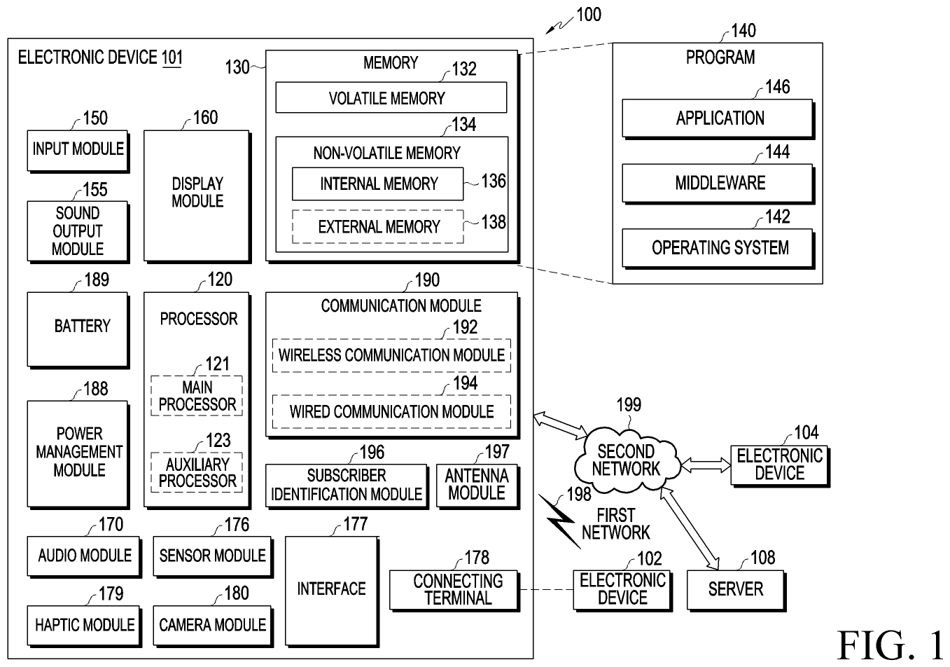

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In various embodiments, at least one (e.g., the display device 160 or the camera module 180) of the components may be omitted from the electronic device 101, or one or more other components may be added in the electronic device 101. In various embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 388 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device). According to an embodiment, the antenna module may include one antenna including a radiator formed of a conductor or conductive pattern formed on a substrate (e.g., a printed circuit board (PCB)). According to an embodiment, the antenna module 197 may include a plurality of antennas. In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 04, or 08. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to various embodiments of the disclosure may be one of various types of electronic devices. The electronic devices may include, for example, a portable communication device (e.g., a smart phone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

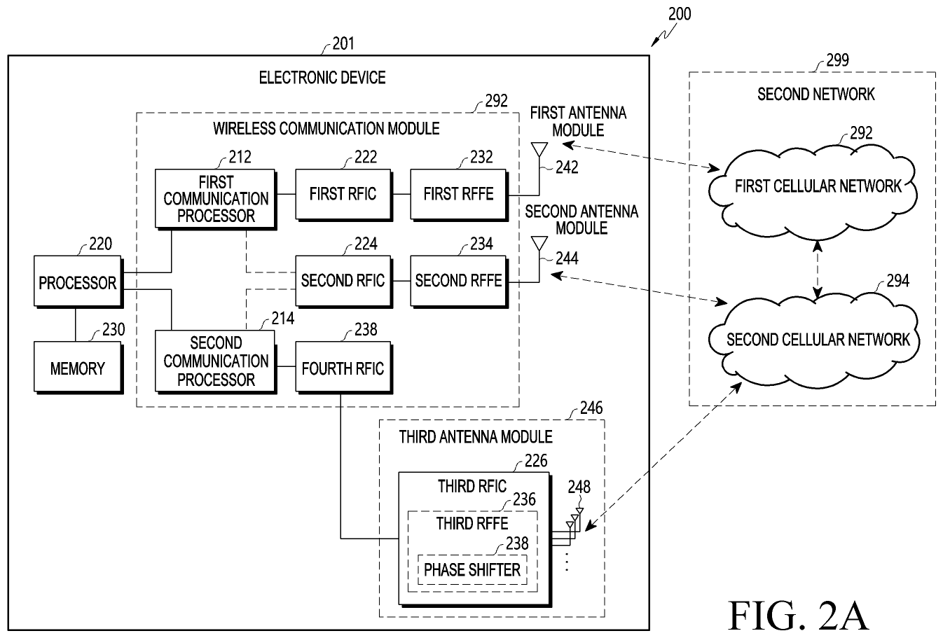

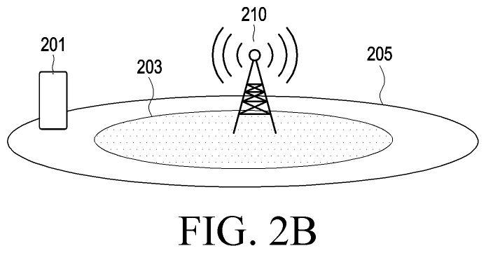

FIG. 2A is a block diagram 200 illustrating an example configuration of an electronic device 101 in a network environment including a plurality of cellular networks according to various embodiments. Referring to FIG. 2A, the electronic device 101 may include a first communication processor (e.g., including processing circuitry) 212, a second communication processor (e.g., including processing circuitry) 214, a first radio frequency integrated circuit (RFIC) 222, a second RFIC 224, a third RFIC 226, a fourth RFIC 228, a first radio frequency front end (RFFE) 232, a second RFFE 234, a first antenna module (e.g., including at least one antenna) 242, a second antenna module (e.g., including at least one antenna) 244, and an antenna 248. The electronic device 101 may further include a processor (e.g., including processing circuitry) 120 and memory 130. The second network 199 may include a first cellular network 292 and a second cellular network 294. According to an embodiment, the electronic device 101 may further include at least one component among the components of FIG. 1, and the second network 199 may further include at least one other network. According to an embodiment, the first communication processor 212, the second communication processor 214, the first RFIC 222, the second RFIC 224, the fourth RFIC 228, the first RFFE 232, and the second RFFE 234 may form at least part of the wireless communication module 192. According to an embodiment, the fourth RFIC 228 may be omitted or be included as part of the third RFIC 226.

The first communication processor 212 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The first communication processor 212 and/may establish a communication channel of a band that is to be used for wireless communication with the first cellular network 292 or may support legacy network communication via the established communication channel. According to various embodiments, the first cellular network may be a legacy network that includes second generation (2G), third generation (3G), fourth generation (4G), or long-term evolution (LTE) networks. The second CP 214 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The second CP 214 may establish a communication channel corresponding to a designated band (e.g., from about 6 GHz to about 60 GHz) among bands that are to be used for wireless communication with the second cellular network 294 or may support fifth generation (5G) network communication via the established communication channel. According to an embodiment, the second cellular network 294 may be a 5G network defined by the 3rd generation partnership project (3GPP). Additionally, according to an embodiment, the first CP 212 or the second CP 214 may establish a communication channel corresponding to another designated band (e.g., about 6 GHz or less) among the bands that are to be used for wireless communication with the second cellular network 294 or may support fifth generation (5G) network communication via the established communication channel. According to an embodiment, the first CP 212 and the second CP 214 may be implemented in a single chip or a single package. According to an embodiment, the first CP 212 or the second CP 214, along with the processor 120, an assistance processor 123, or communication module 190, may be formed in a single chip or single package.

Upon transmission, the first RFIC 222 may convert a baseband signal generated by the first CP 212 into a radio frequency (RF) signal with a frequency ranging from about 700 MHz to about 3 GHz which is used by the first cellular network 292 (e.g., a legacy network). Upon receipt, the RF signal may be obtained from the first cellular network 292 (e.g., a legacy network) through an antenna (e.g., the first antenna module 242) and be pre-processed via an RFFE (e.g., the first RFFE 232). The first RFIC 222 may convert the pre-processed RF signal into a baseband signal that may be processed by the first CP 212.

Upon transmission, the second RFIC 224 may convert the baseband signal generated by the first CP 212 or the second CP 214 into a Sub6-band (e.g., about 6 GHz or less) RF signal (hereinafter, “5G Sub6 RF signal”) that is used by the second cellular network 294 (e.g., a 5G network). Upon receipt, the 5G Sub6 RF signal may be obtained from the second cellular network 294 (e.g., a 5G network) through an antenna (e.g., the second antenna module 244) and be pre-processed via an RFFE (e.g., the second RFFE 234). The second RFIC 224 may convert the pre-processed 5G Sub6 RF signal into a baseband signal that may be processed by a corresponding processor of the first communication processor 212 and the second communication processor 214.

The third RFIC 226 may convert the baseband signal generated by the second CP 214 into a 5G Above6 band (e.g., from about 6 GHz to about 60 GHz) RF signal (hereinafter, “5G Above6 RF signal”) that is to be used by the second cellular network 294 (e.g., a 5G network). Upon receipt, the 5G Above6 RF signal may be obtained from the second cellular network 294 (e.g., a 5G network) through an antenna (e.g., the antenna 248) and be pre-processed via the third RFFE 236. The third RFIC 226 may convert the pre-processed 5G Above6 RF signal into a baseband signal that may be processed by the second communication processor 214. According to an embodiment, the third RFFE 236 may be formed as part of the third RFIC 226.

According to an embodiment, the electronic device 101 may include the fourth RFIC 228 separately from, or as at least part of, the third RFIC 226. In this case, the fourth RFIC 228 may convert the baseband signal generated by the second communication processor 214 into an intermediate frequency band (e.g., from about 9 GHz to about 11 GHz) RF signal (hereinafter, “IF signal”) and transfer the IF signal to the third RFIC 226. The third RFIC 226 may convert the IF signal into a 5G Above6 RF signal. Upon receipt, the 5G Above6 RF signal may be received from the second cellular network 294 (e.g., a 5G network) through an antenna (e.g., the antenna 248) and be converted into an IF signal by the third RFIC 226. The fourth RFIC 228 may convert the IF signal into a baseband signal that may be processed by the second communication processor 214.

According to an embodiment of the disclosure, the first RFIC 222 and the second RFIC 224 may be implemented as at least part of a single chip or single package. According to an embodiment, the first RFFE 232 and the second RFFE 234 may be implemented as at least part of a single chip or single package. According to an embodiment, at least one of the first antenna module 242 or the second antenna module 244 may be omitted or be combined with another antenna module to process multi-band RF signals.

According to an embodiment of the disclosure, the third RFIC 226 and the antenna 248 may be disposed on the same substrate to form the third antenna module 246. For example, the wireless communication module 192 or the processor 120 may be disposed on a first substrate (e.g., a main painted circuit board (PCB)). In this case, the third RFIC 226 and the antenna 248, respectively, may be disposed on one area (e.g., the bottom) and another (e.g., the top) of a second substrate (e.g., a sub PCB) which is provided separately from the first substrate, forming the third antenna module 246. Placing the third RFIC 226 and the antenna 248 on the same substrate may shorten the length of the transmission line therebetween. This may reduce a loss (e.g., attenuation) of high-frequency band (e.g., from about 6 GHz to about 60 GHz) signal used for 5G network communication due to the transmission line. Thus, the electronic device 101 may enhance the communication quality with the second cellular network 294 (e.g., a 5G network).

According to an embodiment of the disclosure, the antenna 248 may be formed as an antenna array which includes a plurality of antenna elements available for beamforming. In this case, the third RFIC 226 may include a plurality of phase shifters 238 corresponding to the plurality of antenna elements, as part of the third RFFE 236. Upon transmission, the plurality of phase shifters 238 may change the phase of the 5G Above6 RF signal which is to be transmitted to the outside (e.g., a 5G network base station) of the electronic device 101 via their respective corresponding antenna elements. Upon receipt, the plurality of phase shifters 238 may change the phase of the 5G Above6 RF signal received from the outside to the same or substantially the same phase via their respective corresponding antenna elements. This enables transmission or reception via beamforming between the electronic device 101 and the outside.

According to an embodiment of the disclosure, the second cellular network 294 (e.g., a 5G network) may be operated independently (e.g., as standalone (SA)) from, or in connection (e.g., as non-standalone (NSA)) with the first cellular network 292 (e.g., a legacy network). For example, the 5G network may have the access network (e.g., 5G radio access network (RAN) or next generation RAN (NG RAN)) but may not have the core network (e.g., next generation core (NGC)). In this case, the electronic device 101, after accessing a 5G network access network, may access an external network (e.g., the Internet) under the control of the core network (e.g., the evolved packet core (EPC)) of the legacy network. Protocol information (e.g., LTE protocol information) for communication with the legacy network or protocol information (e.g., New Radio (NR) protocol information) for communication with the 5G network may be stored in the memory 230 and be accessed by other components (e.g., the processor 120, the first communication processor 212, or the second communication processor 214).

FIG. 2B is a diagram illustrating a change in uplink coverage due to a reduction in maximum transmission power of an electronic device according to various embodiments. When the electronic device (101 of FIG. 1, 201 of FIG. 2A, 201 of FIG. 2B) according to an embodiment of the disclosure has a band to be protected at an adjacent frequency, lowers maximum transmission power to meet a spurious standard, or applies AMPR, the UL coverage may be reduced from the original coverage area 205 of FIG. 2B to the coverage area 203 to which AMPR is applied, and if the UL coverage is reduced, the transmission capability may be reduced, causing inconvenience to the user. For example, as a method that may be performed when nonconformity occurs in a spurious-related standard test, first, there is a method of lowering the maximum transmission power of the electronic device or applying AMPR for each network signaling (NS) specified in 3GPP. Alternatively, in order to minimize/reduce spurious radiation, the standard requirement should be satisfied by changing the impedance by changing the RF front end (RFFE) terminal matching element of the electronic device (101 of FIG. 1, 201 of FIG. 2A, 201 of FIG. 2B), changing the radiation pattern by changing the antenna pattern, or the like. This operation may not only take a long time, but may also reduce transmission capability and increase current consumption of the electronic device. If the maximum transmission power of the electronic device is lowered or AMPR is applied, uplink (UL) coverage may be reduced. Accordingly, there is disclosed a method in which the electronic device (101 of FIG. 1, 201 of FIG. 2A, 201 of FIG. 2B) according to an embodiment may meet the spurious-related standard without lowering maximum transmission power or applying AMPR, or may not invade a protection band without loss of UL coverage.

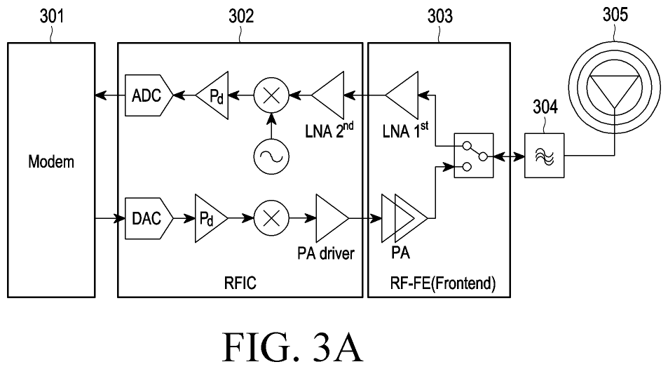

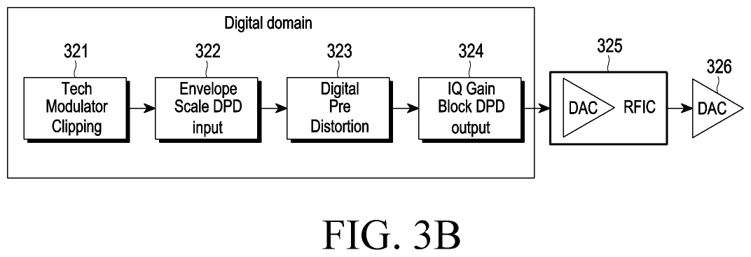

FIG. 3A is a diagram illustrating an example configuration of an electronic device (101 of FIG. 1, 201 of FIG. 2A, 201 of FIG. 2B) according to various embodiments. FIG. 3B is a diagram illustrating a digital domain of a configuration of an electronic device according to various embodiments.

The electronic device (101 of FIG. 1, 201 of FIG. 2A, 201 of FIG. 2B) according to an embodiment may include a modem (301 of FIG. 3A), an RFIC (302 of FIG. 3A), an RF front end (RFFE) (303 of FIG. 3A), and an antenna (305 of FIG. 3A). For example, the modem (301 of FIG. 3A) may include a central processing unit that functions as a modem as a communication processor of the electronic device. The modem (301 of FIG. 3A) may generate and adjust a digital baseband signal and transfer the same to the RFIC (302 of FIG. 3A). For example, the RFIC (302 of FIG. 3A) may convert the baseband signal received from the modem (301 of FIG. 3A) into an analog RF signal and control the RFFE (303 of FIG. 3A). For example, the RFFE (303 of FIG. 3A) may amplify and/or filter (304 of FIG. 3A) the RF signal provided from the RFIC (302 of FIG. 3A) and transmit the same to the antenna (305 of FIG. 3A).

The spurious-related characteristics of the electronic device (101 of FIG. 1, 201 of FIG. 2A, 201 of FIG. 2B) according to an embodiment may have a higher correlation with the output of the RFIC (302 of FIG. 3A) than the RFFE (303 of FIG. 3A). In general, determining the RFIC output focuses on the transmission quality rather than spurious characteristics, and a predetermined value may be fixedly used. There may be disclosed a method in which the electronic device (101 of FIG. 1, 201 of FIG. 2A, 201 of FIG. 2B) according to various embodiments varies the RFIC output setting value according to the uplink environment and uses the same.

According to an embodiment of the disclosure, when the electronic device (101 of FIG. 1, 201 of FIG. 2A, 201 of FIG. 2B) receives a network signaling (NS) value broadcast by a base station (210 of FIG. 2B) through a system information block (SIB) 2, it may be known that there is a frequency to be protected therearound. However, it is not a problem when the transmission power itself is not high, so there is no need to consider changing the RFIC output. Accordingly, if the electronic device (101 of FIG. 1, 201 of FIG. 2A, 201 of FIG. 2B) receives a network signaling message from the base station (210 of FIG. 2B) and the base station (210 of FIG. 2B) requests transmission power close to the maximum transmission power set in the electronic device (101 of FIG. 1, 201 of FIG. 2A, 201 of FIG. 2B), connection is made with the RFIC output set as a value optimized for spurious reduction, and otherwise, with a value optimized for enhancing transmission quality.

In the electronic device (101 of FIG. 1, 201 of FIG. 2A, 201 of FIG. 2B) according to an embodiment, the change of the setting value of the RFIC output may be performed in a digital domain of the modem (301 of FIG. 3A) and/or the RFIC (302 of FIG. 3A). Referring to FIG. 3B, the digital domain (321, 322, 323, 324 of FIG. 3B) of the CP modem (301 of FIG. 3A) and/or of the RFIC (302 of FIG. 3A) of the electronic device (101 of FIG. 1, 201 of FIG. 2A, 201 of FIG. 2B) may include a tech modulator clipping (321 of FIG. 3B), an envelope scale DPD input (322 of FIG. 3B), a digital pre-distortion (323 of FIG. 3B), and/or an IQ gain block DPD output (324 of FIG. 3B) terminal. For example, a signal passing through the digital domain (321, 322, 323, 324 of FIG. 3B) of the CP modem 301 and/or the RFIC 302 of the electronic device (101 of FIG. 1, 201 of FIG. 2A, 201 of FIG. 2B) may be transmitted as an RFIC signal through a digital analog converter (DAC) (326 of FIG. 3B).

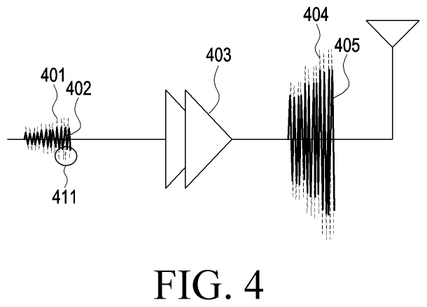

FIG. 4 is a diagram illustrating a change in output of an RFIC according to various embodiments.

In the electronic device (101 of FIG. 1, 201 of FIG. 2A, 201 of FIG. 2B) according to an embodiment, setting the RFIC output according to the transmission quality or the spurious characteristic in the digital domain (321, 322, 323, 324 of FIG. 3B) of the CP modem (301 of FIG. 3A) and/or the RFIC (302 of FIG. 3A) may refer, for example, to adjusting the side lobe level by adjusting the clipping amount. For example, if the size of the signal of the RFIC is reduced according to the clipping amount, the side lobe level is also reduced, thereby enhancing transmission performance considering spurious characteristics. If the size of the signal of the RFIC is increased by adjusting the clipping amount, the spurious component may be increased, but may be advantageous in terms of transmission quality. For example, the clipping amount of the signal may be varied according to whether network signaling is performed and the channel environment.

FIG. 4 illustrates a signal in which the clipping amount is adjusted according to the channel environment and the situation in the digital domain (321, 322, 323, 324 of FIG. 3B) of the CP modem (301 of FIG. 3A) and/or the RFIC (302 of FIG. 3A) of the electronic device (101 of FIG. 1, 201 of FIG. 2A, 201 of FIG. 2B). For example, the first signal (402 of FIG. 4) may be an RF signal converted from a baseband signal in which the clipping amount is adjusted to a first level. The clipping amount of the first level may be, e.g., a value optimized for a spurless characteristic. The second signal (401 of FIG. 4) may be an RF signal converted from a baseband signal in which the clipping amount is adjusted to a second level. The clipping amount at the second level may be, e.g., a value optimized for enhancing transmission quality. Referring to FIG. 4, the clipping amount at the first level (411 of FIG. 4) may be larger than the clipping amount at the second level (411 of FIG. 4). Accordingly, the amplitude of the more clipped first signal (402 of FIG. 4) may be smaller than the amplitude of the second signal (401 of FIG. 4). As shown in FIG. 4, the amplitude of the RF signal may be adjusted by adjusting the clipping amount to the first level or the second level in the digital domain. For example, the amplitude-adjusted first signal (402 of FIG. 4) and/or second signal (401 of FIG. 4) may pass through the power amplifier (403 of FIG. 4). For example, even if the signal whose amplitude is adjusted by clipping is amplified by the power amplifier (403 of FIG. 4), it may be output as an amplified signal (404 of FIG. 4) focusing on the transmission quality of the signal and/or an amplified signal (405 of FIG. 4) tailored to the spurious standard.

According to various embodiments of the disclosure, the electronic device (101 of FIG. 1, 201 of FIG. 2A, 201 of FIG. 2B) may check the uplink environment after determining an RFIC output. For example, when the uplink environment meets a predetermined condition, the electronic device (101 of FIG. 1, 201 of FIG. 2A, 201 of FIG. 2B) may set the RFIC output to a value optimized for spurious reduction, and when the uplink environment does not meet the predetermined condition, may set the RFIC output to a value optimized for enhancing transmission quality. For example, the condition of the uplink environment checked by the electronic device (101 of FIG. 1, 201 of FIG. 2A, 201 of FIG. 2B) may identify whether the difference between the transmission power required by the base station (210 of FIG. 2B) and the maximum transmission power set in the electronic device (101 of FIG. 1, 201 of FIG. 2A, 201 of FIG. 2B) is a designated difference or less. Alternatively, it may be to identify whether the signal reception strength of the electronic device (101 of FIG. 1, 201 of FIG. 2A, 201 of FIG. 2B) is a threshold reception strength value or less, the MCS is a threshold MCS value or less, and the uplink BLER is a threshold BLER value or less.

According to an embodiment of the disclosure, parameters related to the uplink environment may be as shown in Equation 1 or Equation 2.

$$Preq \geq ( P max - 2 dBm ) \qquad [ Equation l ]$$

$$RSRP < - 100 , MCS < 19 , ULBLER < 10 \% \qquad [ Equation 2 ]$$

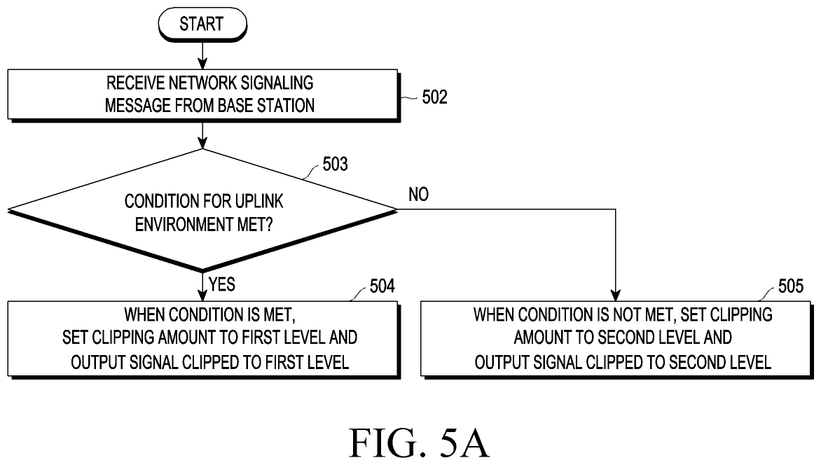

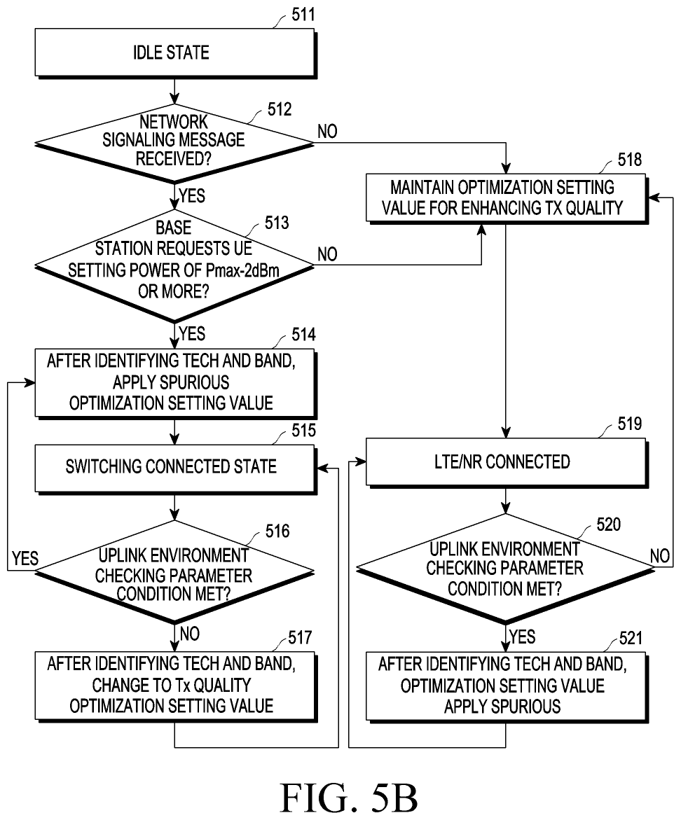

FIG. 5A is a flowchart illustrating example operations of an electronic device (101 of FIG. 1, 201 of FIG. 2A, 201 of FIG. 2B) according to various embodiments. FIG. 5B is a flowchart illustrating example operations of an electronic device according to various embodiments.

Referring to FIG. 5A, in operation 502, the electronic device (101 of FIG. 1, 201 of FIG. 2A, 201 of FIG. 2B) may receive a network signaling message from a base station (210 of FIG. 2B). In operation 503, the electronic device (101 of FIG. 1, 201 of FIG. 2A, 201 of FIG. 2B) may identify whether a condition for the uplink environment is satisfied.

For example, when the condition is satisfied (yes-503 of FIG. 5A), in operation 504, the electronic device (101 of FIG. 1, 201 of FIG. 2A, 201 of FIG. 2B) may set the clipping amount of the signal to a first level (411 of FIG. 4), and may output a signal clipped to the first level (411 of FIG. 4). For example, when the condition is satisfied (yes-503 of FIG. 5A), the difference between the transmission power (e.g., about 22 dBm or more) required by the base station (210 in FIG. 2B) and the maximum transmission power (e.g., about 24 dBm) set in the electronic device (101 in FIG. 1, 201 in FIG. 2A, or 201 in FIG. 2B) may be a designated difference or less. As another example, when the condition is satisfied (yes-503 of FIG. 5A) may be when the reception strength is a threshold reception strength or less, the MCS is a threshold MCS or less, and/or the uplink BLER is a threshold BLER or less. For example, when the condition is met, the clipping amount may be set to the first level (411 of FIG. 4) so that the electronic device (101 of FIG. 1, 201 of FIG. 2A, 201 of FIG. 2B) may make a configuration to set the RFIC output based on the spurious reduction mode.

For example, when the condition is not satisfied (no-503 of FIG. 5A), in operation 505, the electronic device (101 of FIG. 1, 201 of FIG. 2A, 201 of FIG. 2B) may set the clipping amount of the signal to a second level (not shown) to output a signal clipped to the second level. For example, when the condition is not satisfied (no-503 of FIG. 5A) may be when the difference between the transmission power (e.g., less than about 22 dBm) required by the base station (210 of FIG. 2B) and the maximum transmission power (e.g., about 24 dBm) set in the electronic device exceeds the designated difference. For example, when the condition is not satisfied (no-503 of FIG. 5A) may be when the reception strength exceeds the threshold reception strength value, the MCS exceeds the threshold MCS value, and/or the uplink BLER exceeds the threshold BLER value. For example, when the condition is not satisfied (no-503 of FIG. 5A), the electronic device (101 of FIG. 1, 201 of FIG. 2A, 201 of FIG. 2B) of the disclosure may set the clipping amount to the second level (not shown), and configure the electronic device (101 of FIG. 1, 201 of FIG. 2A, 201 of FIG. 2B) to set the RFIC output based on the transmission quality enhancement mode.

FIG. 5B illustrates example operations of an electronic device (101 of FIG. 1, 201 of FIG. 2A, 201 of FIG. 2B) according to various embodiments. In operation 511, the electronic device (101 of FIG. 1, 201 of FIG. 2A, 201 of FIG. 2B) may be in an idle state. In operation 512, the electronic device (101 of FIG. 1, 201 of FIG. 2A, 201 of FIG. 2B) in the idle state may receive a network signaling message. For example, if the electronic device (101 of FIG. 1, 201 of FIG. 2A, 201 of FIG. 2B) receives a network signaling message, the electronic device (101 of FIG. 1, 201 of FIG. 2A, 201 of FIG. 2B) may know that there is a frequency to be protected around. For example, when the electronic device (101 of FIG. 1, 201 of FIG. 2A, 201 of FIG. 2B) receives a request for high transmission power when transmitting a signal from the base station (210 of FIG. 2B), a transmission quality and a spurious standard will be considered.

According to an embodiment of the disclosure, when the electronic device (101 of FIG. 1, 201 of FIG. 2A, 201 of FIG. 2B) does not receive the network signaling message (no-512 of FIG. 5B), in operation 518, the electronic device may set the RFIC output to a setting value for optimizing the transmission quality enhancement. For example, when network signaling does not come from the base station (210 of FIG. 2B), or low transmission power is requested, the RFIC (302 of FIG. 3A) setting may be set to a setting focused on the transmission quality.

According to an embodiment of the disclosure, when the electronic device (101 of FIG. 1, 201 of FIG. 2A, 201 of FIG. 2B) receives the network signaling message (yes-512 of FIG. 5B), in operation 513, the base station (210 of FIG. 2B) may identify whether a specific condition is met. For example, the base station (210 of FIG. 2B) may identify whether the difference between the maximum transmission power of the electronic device (101 of FIG. 1, 201 of FIG. 2A, 201 of FIG. 2B) and the transmission power of the electronic device (101 of FIG. 1, 201 of FIG. 2A, 201 of FIG. 2B) required by the base station (210 of FIG. 2B) is a threshold difference (e.g., about 2 dBm) or more. For example, the electronic device (101 of FIG. 1, 201 of FIG. 2A, 201 of FIG. 2B) may identify whether transmission power which has a value within the threshold difference (e.g., about 2 dBm) from the maximum transmission power of the electronic device (101 of FIG. 1, 201 of FIG. 2A, 201 of FIG. 2B) is requested. For example, the electronic device (101 of FIG. 1, 201 of FIG. 2A, 201 of FIG. 2B) may identify the condition of the uplink environment. For example, the electronic device (101 of FIG. 1, 201 of FIG. 2A, 201 of FIG. 2B) may identify whether to apply a setting value optimized for spurious reduction. For example, the electronic device (101 of FIG. 1, 201 of FIG. 2A, 201 of FIG. 2B) may make a setting for setting the RFIC output based on the spurious reduction mode. For example, it may be identified whether the signal reception strength of the electronic device (101 of FIG. 1, 201 of FIG. 2A, 201 of FIG. 2B) is a threshold reception strength value or more, the MCS is a threshold MCS value or more, and the uplink BLER is a threshold BLER value or more.

For example, when the transmission power requested by the base station (210 of FIG. 2B) from the electronic device (101 of FIG. 1, 201 of FIG. 2A, 201 of FIG. 2B) is not large (no-513 of FIG. 5B), the electronic device may maintain the RFIC output as a setting value for optimizing transmission quality enhancement (518 of FIG. 5B). For example, when the transmission power requested by the base station (210 of FIG. 2B) from the electronic device (101 of FIG. 1, 201 of FIG. 2A, 201 of FIG. 2B) is so large as to differ within the threshold difference (e.g., about 2 dBm) from the maximum transmission power (yes-513 of FIG. 5B), in operation 514, the electronic device (101 of FIG. 1, 201 of FIG. 2A, 201 of FIG. 2B) may identify tech and/or band, and then may apply an optimal setting value for spurious reduction. For example, the tech and/or band may identify the communication generation (e.g., 3G, 4G, 5G, etc.) used by the electronic device (101 of FIG. 1, 201 of FIG. 2A, 201 of FIG. 2B) and the frequency band to be used for signal transmission, and may set an RFIC output to a setting value considering spurious characteristics.

According to an embodiment of the disclosure, when the signal reception strength of the electronic device (101 of FIG. 1, 201 of FIG. 2A, 201 of FIG. 2B) exceeds the threshold reception strength value, the MCS exceeds the threshold MCS value, and/or the uplink BLER exceeds the threshold BLER value (no-513 of FIG. 5B), the electronic device (101 of FIG. 1, 201 of FIG. 2A, 201 of FIG. 2B) may maintain (518 of FIG. 5B) the RFIC output as a setting value for optimizing transmission quality enhancement. For example, when the signal reception strength of the electronic device (101 of FIG. 1, 201 of FIG. 2A, 201 of FIG. 2B) is the threshold reception strength or less, the MCS is the threshold MCS or less, and/or the uplink BLER is the threshold BLER or less (yes-513 of FIG. 5B), in operation 514, the electronic device (101 of FIG. 1, 201 of FIG. 2A, 201 of FIG. 2B) may identify tech and/or band, and then may apply an optimization setting value for spurious reduction. For example, the tech and/or band may identify the communication generation (e.g., 3G, 4G, 5G, etc.) used by the electronic device (101 of FIG. 1, 201 of FIG. 2A, 201 of FIG. 2B) and the frequency band to be used for signal transmission, and may set an RFIC output to a setting value considering spurious characteristics. For example, when the electronic device (101 of FIG. 1, 201 of FIG. 2A, 201 of FIG. 2B) is configured with the setting value for optimizing the transmission quality, the electronic device (101 of FIG. 1, 201 of FIG. 2A, 201 of FIG. 2B) may change the RFIC output to a setting value considering spurious characteristics according to the identification of the condition.

According to an embodiment of the disclosure, in operation 515, the electronic device (101 of FIG. 1, 201 of FIG. 2A, 201 of FIG. 2B) may be switched to the connected state and may identify a specific condition for the uplink environment.

According to an embodiment of the disclosure, in operation 516, the electronic device (101 of FIG. 1, 201 of FIG. 2A, 201 of FIG. 2B) may identify whether the parameters for the uplink environment meet a specific condition. For example, the electronic device (101 of FIG. 1, 201 of FIG. 2A, 201 of FIG. 2B) may identify whether a specific condition is satisfied based on Equation 1 and/or Equation 2. For example, when the condition is satisfied (yes-516 of FIG. 5B), the electronic device (101 of FIG. 1, 201 of FIG. 2A, 201 of FIG. 2B) may maintain (514 of FIG. 5B) an optimization setting value for spurious reduction. For example, when the condition is satisfied (yes-516 of FIG. 5B), the base station (210 of FIG. 2B) may identify whether the difference between the maximum transmission power of the electronic device (101 of FIG. 1, 201 of FIG. 2A, 201 of FIG. 2B) and the transmission power of the electronic device (101 of FIG. 1, 201 of FIG. 2A, 201 of FIG. 2B) requested by the base station (210 of FIG. 2B) is a threshold difference (e.g., about 2 dBm) or more. It may be identified whether the signal reception strength of the electronic device (101 of FIG. 1, 201 of FIG. 2A, 201 of FIG. 2B) is a threshold reception strength value or less, the MCS is a threshold MCS value or less, and/or the uplink BLER is a threshold BLER value or less.

However, when the condition is not satisfied (no-516 of FIG. 5B), in operation 517, the communication generation (e.g., 3G, 4G, and 5G) and frequency band used by the electronic device (101 of FIG. 1, 201 of FIG. 2A, 201 of FIG. 2B) may be identified, and the RFIC output may be changed to a setting value for optimizing the transmission quality. For example, when the condition is not satisfied (no-516 of FIG. 5B), the base station (210 of FIG. 2B) may identify whether the difference between the maximum transmission power of the electronic device (101 of FIG. 1, 201 of FIG. 2A, 201 of FIG. 2B) and the transmission power of the electronic device (101 of FIG. 1, 201 of FIG. 2A, 201 of FIG. 2B) requested by the base station (210 of FIG. 2B) is less than the threshold difference (e.g., 2 dBm), the signal reception strength of the electronic device (101 of FIG. 1, 201 of FIG. 2A, 201 of FIG. 2B) exceeds the threshold reception strength value, the MCS exceeds the threshold MCS value, and/or the uplink BLER exceeds the threshold BLER value. The electronic device (101 of FIG. 1, 201 of FIG. 2A, 201 of FIG. 2B) may continuously change the RFIC output suitable for the electronic device (101 of FIG. 1, 201 of FIG. 2A, 201 of FIG. 2B) based on the uplink environment in the LTE and/or NR connected state (515 of FIG. 5B) even after the RFIC output is set to the setting value optimized for the enhancement of the transmission quality.

According to an embodiment of the disclosure, in operation 520, in the electronic device (101 of FIG. 1, 201 of FIG. 2A, 201 of FIG. 2B) set with the optimization setting value of transmission quality, the electronic device (101 of FIG. 1, 201 of FIG. 2A, 201 of FIG. 2B) in the LTE and/or NR connected state (519 of FIG. 5B) may identify a specific condition for the uplink environment in operation 520. For example, the electronic device (101 of FIG. 1, 201 of FIG. 2A, 201 of FIG. 2B) may identify whether the condition for the uplink environment is satisfied considering the parameters of Equation 1 and/or Equation 2. For example, when the condition is not satisfied (no-520 of FIG. 5B), the electronic device (101 of FIG. 1, 201 of FIG. 2A, 201 of FIG. 2B) may maintain (518 of FIG. 5B) an optimization setting value for enhancing transmission quality. However, when the condition is not satisfied (yes-520 of FIG. 5B), in operation 521, the communication generation (e.g., 3G, 4G, and 5G) and frequency band used by the electronic device (101 of FIG. 1, 201 of FIG. 2A, 201 of FIG. 2B) may be identified, and the RFIC output may be changed to an optimization setting value for spurious reduction considering spurious characteristics.

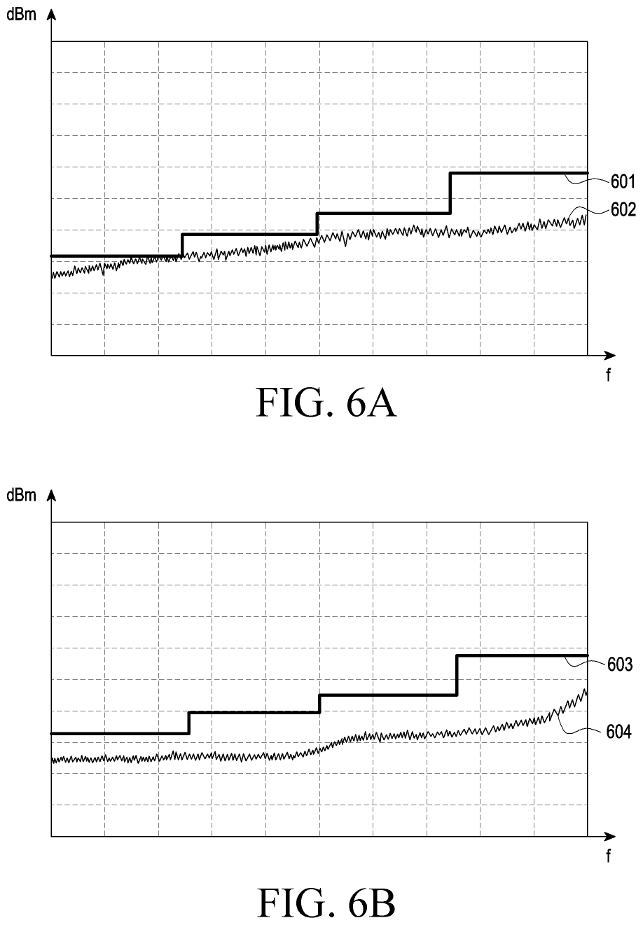

FIG. 6A is a graph illustrating a spurious specification and a measurement value of a spurious component, and FIG. 6B is a graph a reduction in spurious component according to a power setting according to various embodiments.

Referring to FIGS. 6A and 6B, it may be identified through an experiment that the spurious component is reduced without degrading the transmission capability of the signal. Referring to FIG. 6A, in the graph for the dBm (y-axis) value for each frequency (x-axis), the dBm interval between the thick solid line 601 of FIG. 6A and the measured solid line 602 of FIG. 6 indicating the standard in the portion where the frequency rises is generally close. Referring to FIG. 6B, it may be identified that the performance of the band edge is enhanced in the graph for the dBm (y-axis) value for each frequency (x-axis). As an example, it may be identified that when the method and device of the disclosure is applied, the interval between the thick solid line 603 of FIG. 6B and the measured solid line 604 of FIG. 6B indicating the standard is more than about 5 dBm. In FIG. 6B, as compared with FIG. 6A, it may be identified that the spurious component is further lowered when the power setting according to an embodiment of the disclosure is applied. As a result, it may be identified that the spurious component is lowered even without maintaining the maximum transmission power and applying AMPR, and that the spurious specification and margin are generated without deteriorating transmission capability. For example, the experimental values measured before and after applying the EVM, which is a representative performance indicator of transmission quality, may be identified as shown in Table 1.

TABLE 1

| | Default Operation | | | RFIC Setting Change | | |
|---|---|---|---|---|---|---|
| EVM(17.5%) | 55265 | 55990 | 56715 | 55265 | 55990 | 56715 |
| 5 MHz | 1.5 | 1.17 | 1.46 | 1.49 | 1.59 | 1.37 |
| 10 MHz | 1.34 | 1.11 | 1.19 | 1.2 | 1.4 | 1.64 |
| 15 MHz | 2.03 | 2.04 | 2.16 | 2.95 | 3 | 3.15 |
| 20 MHz | 1.13 | 1.17 | 1.13 | 1.43 | 1.36 | 1.38 |

Referring to Table 1, when the RFIC setting is changed in the default operation, the change of the EVM may also be identified to be less than about 5%. Therefore, it may be identified that the EVM performance has a sufficient margin compared to the specifications, along with the spurious enhancement, contrary to the concern that the transmission quality will be deteriorated if the spurious performance is prioritized.

According to an embodiment of the disclosure, when the base station (210 of FIG. 2B) does not receive the network signaling message or the base station (210 of FIG. 2B) requests low transmission power, the RFIC output may be set to a setting focused on the transmission quality. In other words, in various embodiments of the disclosure, the characteristic that the RFIC output may be variably configured may be applied to various technical fields. For example, it may be identified whether the RFIC output is changed according to the context by identifying the CSE or the band edge as a spectrum depending on whether the device receives network signaling.

According to an example embodiment of the disclosure, in a method by an electronic device (e.g., 101 of FIG. 1, 201 of FIG. 2A, 201 of FIG. 2B) in a wireless communication system, the electronic device (e.g., 101 of FIG. 1, 201 of FIG. 2A, 201 of FIG. 2B) may perform a method comprising: receiving a network signaling message from a base station (e.g., 210 of FIG. 2B; identifying whether the electronic device meets a condition for an uplink environment; based on the condition being satisfied, setting a clipping amount to a first level (e.g., 411 of FIG. 4) and outputting a signal clipped to the first level (e.g., 411 of FIG. 4; and based on the condition for the uplink environment not being satisfied, setting the clipping amount to a second level (not shown) and outputting a signal clipped to the second level (not shown).

According to an example embodiment of the disclosure, setting the clipping amount to the first level (e.g., 411 of FIG. 4) and outputting the signal clipped to the first level (e.g., 411 of FIG. 4), may comprise: setting the clipping amount to the first level (e.g., 411 of FIG. 4) based on a spurious reduction mode. The setting the clipping amount to the second level (not shown) and outputting the signal clipped to the second level, may comprise: setting the clipping amount to the second level (not shown) based on a transmission quality enhancement mode. According to an example embodiment, the first level (e.g., 411 of FIG. 4) may be larger than the second level (not shown).

According to an example embodiment of the disclosure, the condition for the uplink environment is that a difference between transmission power required by the base station and maximum transmission power set in the electronic device (e.g., 101 of FIG. 1, 201 of FIG. 2A, 201 of FIG. 2B) may be a designated difference or less.

According to an example embodiment of the disclosure, the condition for the uplink environment may be whether a reception strength is a threshold reception strength value or less, an MCS is a threshold MCS value or less, and/or an uplink BLER is a threshold BLER value or less.

According to an example embodiment of the disclosure, the electronic device (e.g., 101 of FIG. 1, 201 of FIG. 2A, 201 of FIG. 2B) may include: a modem and a radio frequency integrated circuit (RFIC), and outputting the clipped signal may be performed in a digital domain of the modem and/or the RFIC.

According to an example embodiment of the disclosure, the electronic device (e.g., 101 of FIG. 1, 201 of FIG. 2A, 201 of FIG. 2B) may be configured to receive information about the transmission power from the base station.

According to an example embodiment of the disclosure, the electronic device (e.g., 101 of FIG. 1, 201 of FIG. 2A, 201 of FIG. 2B) may be configured to: based on the condition being satisfied, output a first signal (402 of FIG. 4) clipped to the first level (e.g., 411 of FIG. 4) based on the spurious reduction mode; based on the condition not being satisfied, output a second signal (e.g., 401 of FIG. 4) clipped to the second level (not shown) based on the transmission quality enhancement mode; amplify the first signal (e.g., 402 of FIG. 4) and the second signal (e.g., 401 of FIG. 4) by a power; wherein, an amplitude of the first signal (e.g., 405 of FIG. 4) amplified by the power amplifier may be less than an amplitude of the amplified second signal (e.g., 404 of FIG. 4).

According to an example embodiment of the disclosure, the electronic device (e.g., 101 of FIG. 1, 201 of FIG. 2A, 201 of FIG. 2B) may be configured to: identify whether the condition is satisfied according to the uplink environment in the operation of outputting the signal clipped to the first level (e.g., 411 of FIG. 4; based on the condition being satisfied, maintaining the clipping amount as the first level (e.g., 411 of FIG. 4); based on the condition not being satisfied, changing the clipping amount to a second level (not shown).

According to an example embodiment of the disclosure, there may be provided a method in which the first level (411 of FIG. 4) and the second level (not shown) for the clipping amount are identified based on a frequency band used to transmit a signal.

According to an example embodiment of the disclosure, electronic device (e.g., 101 of FIG. 1, 201 of FIG. 2A, 201 of FIG. 2B) of a wireless communication system may comprise: at least one processor, comprising processing circuitry (e.g., 120 of FIG. 1), individually and/or collectively, configured to: receive a network signaling message from a base station; identify whether a condition for an uplink environment is satisfied; based on the condition being satisfied, set a clipping amount to a first level (e.g., 411 of FIG. 4) and output a signal clipped to the first level (e.g., 411 of FIG. 4; and based on the condition not being satisfied, set the clipping amount to a second level (not shown) and output a signal clipped to the second level (not shown).

According to an example embodiment of the disclosure, at least one processor, individually and/or collectively, may be configured to: set the clipping amount to the first level (e.g., 411 of FIG. 4) based on a spurious reduction mode and set the clipping amount to the second level (not shown) based on a transmission quality enhancement mode; wherein, the first level (e.g., 411 of FIG. 4) may be greater than the second level (not shown).

According to an example embodiment of the disclosure, there may be provided the electronic device (101 of FIG. 1, 201 of FIG. 2A, 201 of FIG. 2B) in which the condition for the uplink environment is that a difference between transmission power required by the base station and maximum transmission power set in the electronic device (101 of FIG. 1, 201 of FIG. 2A, 201 of FIG. 2B) is a designated difference or less.

According to various example embodiments, the electronic device (e.g., 101 of FIG. 1, 201 of FIG. 2A, 201 of FIG. 2B) may be provided in which the condition for the uplink environment is that a reception strength is a threshold reception strength value or less, that an MCS is a threshold MCS value or less, and/or that an uplink BLER is a threshold BLER value or less.

According to an example embodiment of the disclosure, the electronic device (e.g., 101 of FIG. 1, 201 of FIG. 2A, 201 of FIG. 2B) may include a modem and an RFIC. Outputting the clipped signal by the at least one processor according to an embodiment may be configured to be performed in a digital domain of the modem and the RFIC.

According to an example embodiment of the disclosure, at least one processor, individually and/or collectively, may be configured to receive information about the transmission power from the base station by the electronic device (e.g., 101 of FIG. 1, 201 of FIG. 2A, 201 of FIG. 2B).

According to an example embodiment of the disclosure, the electronic device (101 of FIG. 1, 201 of FIG. 2A, 201 of FIG. 2B) may further comprise a power amplifier. According to an example embodiment, at least one processor connected to the amplifier may, based on the condition being satisfied, be configured to output a first signal (e.g., 402 of FIG. 4) clipped to the first level (e.g., 411 of FIG. 4) based on the spurious reduction mode. At least one processor according to an example embodiment may, individually and/or collectively, be configured to: based on the condition not being satisfied, output a second signal (e.g., 401 of FIG. 4) clipped to the second level (not shown) based on the transmission quality enhancement mode. At least one processor according to an example embodiment may, individually and/or collectively, be configured to amplify the first signal (e.g., 402 of FIG. 4) and the second signal (e.g., 401 of FIG. 4) by the power amplifier. According to an example embodiment, an amplitude of the amplified first signal (e.g., 405 of FIG. 4) may be smaller than an amplitude of the amplified second signal (e.g., 404 of FIG. 4).

According to an example embodiment of the disclosure, at least one processor outputting the signal clipped to the first level (e.g., 411 of FIG. 4) may, individually and/or collectively, be configured to further identify whether the condition is satisfied according to the uplink environment; maintain the clipping amount as the first level (e.g., 411 of FIG. 4) based on the condition being satisfied; and change the clipping amount to the second level (not shown) based on the condition not being satisfied.

According to an example embodiment of the disclosure, at least one processor, individually and/or collectively, may be configured to: identify the first level (e.g., 411 of FIG. 4) and the second level (not shown) for the clipping amount based on a frequency band used to transmit a signal.

According to an example embodiment of the disclosure, a non-transitory computer-readable storage medium storing one or more programs or a computer program product may comprise instructions which, when executed by at least one processor, comprising processing circuitry, of an electronic device, individually and/or collectively, cause the electronic device to perform operations comprising: receiving a network signaling message from a base station; identifying whether a condition for an uplink environment is satisfied; based on the condition for the uplink environment being satisfied, setting a clipping amount to a first level (e.g., 411 of FIG. 4) and outputting a signal clipped to the first level (e.g., 411 of FIG. 4); and based on the condition for the uplink environment not being satisfied, setting the clipping amount to a second level (not shown) and outputting a signal clipped to the second level (not shown).

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
memory storing instructions; and
at least one processor, comprising processing circuitry,
wherein the instructions include computer-executable instructions that, when executed by the at least one processor, individually and/or collectively, is configured to cause the electronic device to:
receive a network signaling message from a base station;
identify whether a condition for an uplink environment is satisfied;
in response to the condition being satisfied, set a clipping amount to a first level and output a signal clipped to the first level; and
in response to the condition not being satisfied, set the clipping amount to a second level and output a signal clipped to the second level.

2. The electronic device of claim 1, wherein the instructions, when executed by the at least one processor, individually and/or collectively, further cause the electronic device to:
set the clipping amount to the first level based on a spurious reduction mode; and
set the clipping amount to the second level based on a transmission quality enhancement mode, and wherein the first level is greater than the second level.

3. The electronic device of claim 1, wherein the condition for the uplink environment includes a difference between transmission power required by the base station and maximum transmission power set in the electronic device being less than or equal to a designated difference.

4. The electronic device of claim 1, wherein the condition for the uplink environment includes a reception strength being less than or equal to a threshold reception strength value, modulation and coding scheme (MCS) being less than or equal to a threshold MCS value, and/or an uplink block error rate (BLER) being less than or equal to a threshold BLER value.

5. The electronic device of claim 1, wherein the electronic device includes a modem and a radio frequency integrated circuit (RFIC), and wherein outputting the clipped signal by at least one processor is configured to be performed in a digital domain of the modem and the RFIC.

6. The electronic device of claim 1, wherein the instructions, when executed by the at least one processor, individually and/or collectively, further cause the electronic device to:
receive information about the transmission power from the base station.

7. The electronic device of claim 1, further comprising a power amplifier, wherein the instructions, when executed by the at least one processor, individually and/or collectively, further cause the electronic device to:
in response to the condition being satisfied, output a first signal clipped to the first level based on the spurious reduction mode; or
in response to the condition not being satisfied, output a second signal clipped to the second level based on the transmission quality enhancement mode,
wherein the first signal and the second signal are amplified by the power amplifier, and
wherein an amplitude of the amplified first signal is less than an amplitude of the amplified second signal.

8. The electronic device of claim 1, wherein the instructions, when executed by the at least one processor outputting the signal clipped to the first level, further cause the electronic device to:
identify whether the condition is satisfied based on the uplink environment;
in response to the condition being satisfied, maintain the clipping amount as the first level; or
in response to the condition not being satisfied, change the clipping amount to the second level.

9. The electronic device of claim 1, wherein the instructions, when executed by the at least one processor, individually and/or collectively, individually and/or collectively, further cause the electronic device to identify the first level and the second level for the clipping amount based on a frequency band used to transmit a signal.

10. A method performed by an electronic device, the method comprising:
receiving a network signaling message from a base station;
identifying whether a condition for an uplink environment is satisfied by the electronic device;
in response to the condition being satisfied, setting a clipping amount to a first level and outputting a signal clipped to the first level; and
in response to the condition not being satisfied, setting the clipping amount to a second level and outputting a signal clipped to the second level.

11. The method of claim 10, wherein setting the clipping amount to the first level and outputting the signal clipped to the first level sets the clipping amount to the first level based on a spurious reduction mode, and
wherein setting the clipping amount to the second level and outputting the signal clipped to the second level sets the clipping amount to the second level based on a transmission quality enhancement mode, and wherein the first level is greater than the second level.

12. The method of claim 10, wherein the condition for the uplink environment includes a difference between transmission power required by the base station and maximum transmission power set in the electronic device being less than or equal to a designated difference.

13. The method of claim 10, wherein the condition for the uplink environment includes whether a reception strength is less than or equal to a threshold reception strength value, a modulation and coding scheme (MCS) is less than or equal to a threshold MCS value, and/or an uplink block error rate (BLER) is less than or equal to a threshold BLER value.

14. The method of claim 10, wherein the electronic device includes a modem and a radio frequency integrated circuit (RFIC), and wherein outputting the clipped signal is performed in a digital domain of the modem and/or the RFIC.

15. The method of claim 10, further comprising receiving information about the transmission power from the base station.

16. The method of claim 10, further comprising:
in response to the condition being satisfied, outputting a first signal clipped to the first level based on the spurious reduction mode; or
in response to the condition not being satisfied, outputting a second signal clipped to the second level based on the transmission quality enhancement mode,
wherein the first signal and the second signal are amplified by a power amplifier, and
wherein an amplitude of the amplified first signal is less than an amplitude of the amplified second signal.

17. The method of claim 10, wherein the step of outputting the signal clipped to the first level, further comprising:
identifying whether the condition is satisfied based on the uplink environment;
in response to the condition being satisfied, maintaining the clipping amount as the first level; or
in response to the condition not being satisfied, changing the clipping amount to the second level.

18. The method of claim 10, further comprising identifying the first level and the second level for the clipping amount based on a frequency band used to transmit a signal.

19. One or more non-transitory computer-readable storage media storing computer-executable instructions that, when executed by one or more processors individually or collectively, cause an electronic device to perform operations, the operations comprising:
receiving a network signaling message from a base station;
identifying whether a condition for an uplink environment is satisfied by the electronic device;
in response to the condition being satisfied, setting a clipping amount to a first level and outputting a signal clipped to the first level; and
in response to the condition not being satisfied, setting the clipping amount to a second level and outputting a signal clipped to the second level.

20. The one or more non-transitory computer-readable storage media of claim 19, wherein the operations further comprising:
setting the clipping amount to the first level based on a spurious reduction mode; and
setting the clipping amount to the second level based on a transmission quality enhancement mode, and wherein the first level is greater than the second level.
